(19) United States
(12) Patent Application Publication
(10) Pub. No.: US 2025/0269400 A1
(43) Pub. Date: Aug. 28, 2025

(54) METHOD AND ARRANGEMENT FOR APPLYING A COATING TO A BEARING COMPONENT

(71) Applicant: AKTIEBOLAGET SKF, GOTEBORG (SE)

(72) Inventors: Karl PREIS, Traun (AT); Bernhard SCHWARZ, Steyr (AT); René SAXENHUBER-STELLNBERGER, Steyr (AT)

(21) Appl. No.: 19/053,587

(22) Filed: Feb. 14, 2025

(30) Foreign Application Priority Data
Feb. 28, 2024 (DE) 102024201847.3

(51) Int. Cl. B05C 13/02; B05D 3/02

(52) U.S. Cl. CPC B05C 13/025; B05D 3/0254; B05D 2254/02

(57) ABSTRACT

A method includes providing a bearing component in a holding apparatus, applying a defined amount of a coating material to the bearing component, and curing the coating material on the bearing component while using the holding apparatus to rotate the bearing component at a first speed. Also optionally rotating the bearing component at a second speed while applying the defined amount of the coating material. Also an apparatus for performing the method.

### CROSS-REFERENCE

This application claims priority to German patent application no. 10 2024 201 847.3 filed on Feb. 28, 2024, the contents of which are fully incorporated herein by reference.

### TECHNOLOGICAL FIELD

The present disclosure is directed to a method and apparatus for applying a coating to a bearing component.

### BACKGROUND

Depending on a field of use of a bearing component, the bearing component may be provided with a coating in order, for example, to protect it from wear and/or corrosion, to insulate it thermally and/or electrically and/or to seal it. The coating may be present here, for example, in a liquid or powdered precursor.

In the case of bearing components, it is known that a coating originally in liquid form can be applied manually by means of a brush or roller such that there is only limited control over the amount applied and/or the distribution of the coating on the bearing component. This can cause problems in the uniformity of distribution of the coating.

After application, the coating is typically dried and cured. Since this can take some time, it may be the case that the distribution of the initially liquid coating becomes non-uniform because of the force of gravity. It is also possible that droplets are formed, which can accumulate on the lower part of the bearing component viewed in the direction of gravity. This has the disadvantage that uniform or homogeneous distribution of the coating cannot always be ensured.

In the case of droplet formation, it may additionally become necessary to remove the droplets after curing. In addition, there may be a loss of coating when the still-liquid coating flows away from the bearing component. As a result, there may be a risk that the coating on the bearing component is not formed uniformly, such that functionality of the coating cannot be ensured.

A particularly great risk that the coating will drip off the bearing component exists especially when the bearing component is subjected to a heat treatment to cure the coating, since the viscosity of the coating falls with increasing temperature, which further increases the risk of droplet formation.

### SUMMARY

It is therefore an aspect of the present disclosure to provide a method and an arrangement for applying a coating to a bearing component, where the risk of droplet formation is reduced and/or homogeneity of the coating is improved.

What is provided hereinafter is a method of applying a coating to a bearing component, wherein the method comprises the steps of providing a bearing component, applying a defined amount of a coating, and curing the coating.

The bearing component may especially be a bearing ring, for example a bearing ring for a roller bearing or a slide bearing. The ring may especially be an inner ring or an outer ring. In addition, the bearing component may be a rolling body, for example a cylindrical roller, a conical roller, a needle roller, a pendulum roller or the like. The bearing component may have been produced, for example, from a metal, a ceramic and/or a composite.

The defined amount of the coating can preferably be applied by means of a metering system. For example, the metering system may be a robot system having a nozzle designed to spray a defined amount of the coating onto the bearing component. In particular, the metering system may be designed to reproducibly apply a defined amount of the coating per unit area. This makes it possible to achieve a particularly uniform layer thickness. In addition, it is possible to monitor a temperature of the coating on application by means of the metering system, such that the coating is applied to the bearing component at a defined temperature. The coating is preferably applied in a contactless manner.

The coating may especially be a seal, for example a paint, a varnish, a resin, a resin mixture, or the like. In addition, the coating may also be applied on top of an already applied first coating. In particular, the first coating may be a thermal spray layer. For example, the first coating may have been applied by a plasma spraying method and have a porous surface. This porous surface may then in turn be sealed with at least one further coating which is applied by the method described. It is also possible to apply multiple coatings successively by the method described.

In order to reduce the risk of droplet formation, the bearing component is rotated at a first speed of rotation at least during the curing. The first speed of rotation may be a uniform speed of rotation or a cyclical speed of rotation, where the bearing component is moved onward stepwise. Because the bearing component is kept in rotation, it is possible to prevent droplet formation by the coating during curing. This also has the advantage that a more homogeneous distribution of the coating and/or a more uniform layer thickness can be ensured. Since, in particular, the risk of loss of the coating as a result of dripping of the coating off the bearing component can be reduced, it is also possible to reduce the risk of contamination of the working environment.

What is meant in particular by the expression “curing of the coating” is solidification of the coating on the bearing component and/or on a first coating already applied to the bearing component.

Preferably, the bearing component is additionally rotated at a second speed of rotation during the application process. Even in the course of application, this can reduce or prevent droplet formation and/or dripping of the coating. In addition, rotation of the bearing component can also enable more uniform application of the coating. The second speed of rotation may be a uniform speed of rotation or a cyclical speed of rotation, where the bearing component is moved onward stepwise.

Advantageously, a drying step may be provided between the applying and the curing, wherein the bearing component additionally rotates at a third speed of rotation during the drying step. This makes it possible to distribute the coating very substantially uniformly over the bearing component and to prevent droplet formation and/or any other movement of the coating on the bearing component throughout the method, i.e. the application, drying and curing of the coating. The third speed of rotation may be a uniform speed of rotation or a cyclical speed of rotation, where the bearing component is moved onward stepwise.

The drying step can especially also make it possible for a coating which is applied for sealing of a porous layer to penetrate into the pores of the porous layer. The drying step may also make it possible for the coating to stick to the bearing component at least such that at least one further layer of the coating and/or at least one further coating can be applied.

In a further embodiment, the first speed of rotation, the second speed of rotation and/or the third speed of rotation is constant. This means that the speed of rotation is kept constant during the steps of the method.

Alternatively, the first speed of rotation, the second speed of rotation and/or the third speed of rotation may be constant but different from one another and/or each speed of rotation may be variable. In other words, the speed of rotation may be varied. For example, the speed of rotation may be matched to a temperature of the bearing component, an ambient temperature, a viscosity of the coating and/or a size of the bearing component. A variable speed of rotation has the advantage that the speed of rotation can be matched to changes in ambient temperature and/or in viscosity of the coating. For example, in the course of curing, onset of crosslinking of the molecules of the coating may cause the viscosity of the coating to change. It is possible to respond to this change with a variable speed of rotation.

The bearing component is preferably kept in rotation even in the case of any intermediate steps of the method. For example, when the different method steps are conducted at different stations, the bearing component may also be kept in rotation in the course of transport between the different stations, such that the risk of droplet formation can be reduced further.

In addition, the first speed of rotation, the second speed of rotation and/or the third speed of rotation may be equal to one another. In other words, there is no change in the speed of rotation with which the bearing component is rotated between the different steps. In other words, the bearing component rotates at the same speed in the course of application, drying and curing of the coating.

Alternatively, the first speed of rotation, the second speed of rotation and/or the third speed of rotation may be different from one another. For example, the speed of rotation may be matched to a viscosity, an ambient temperature, a temperature of the coating or the like. For example, the rotation on application may be different from the speed of rotation after drying. This makes it possible for the speed of rotation to be matched to the viscosity of the coating, such that it is possible to ensure that droplet formation can be efficiently prevented and a very substantially homogeneous layer thickness is achieved in the coating operation.

In addition, the curing can be effected at a temperature between 15° C. and 300° C. This makes it possible for the coating to cure reliably and stick to the bearing component. In particular, the application and/or drying can be effected within a temperature range between 0° C. and 300° C. This enables uniform application of the coating and drying of the coating.

The method preferably further comprises selecting a speed of rotation depending on a temperature, a size of the bearing component and/or a viscosity of the coating. For example, the speed of rotation may be chosen such that a circumferential speed of the bearing component is within a defined range. Adjustment of the speed of rotation depending on a temperature, a size of the bearing component and/or a viscosity of the coating can ensure that droplet formation can be efficiently prevented. For example, it is possible to ensure that the bearing component rotates sufficiently quickly to prevent the formation of droplets. It is also possible to ensure that the coating is not spun off the bearing component owing to excessively high centrifugal forces by keeping the speed of rotation below a defined limit.

In a further aspect, an arrangement for application of a coating to a bearing component is proposed. The arrangement comprises an apparatus designed to apply a coating to a bearing component, a holding apparatus designed to hold the bearing component, and a curing device designed to cure the coating on the bearing component, wherein the holding apparatus is designed to rotate the bearing component at least during the curing. The arrangement may especially be designed to execute the above-described method.

In particular, the apparatus for application of a coating to the bearing component is designed to apply the coating in a contactless manner. The apparatus may, for example, be a metering system having a robot system and a nozzle for application of a defined amount of the coating. In particular, the apparatus may be designed to keep the coating at a defined temperature.

In addition, the holding apparatus may be designed to rotate the bearing component at a constant and/or variable speed of rotation. In particular, the holding apparatus may be designed to rotate the bearing component at a defined rotational speed in the course of application of the coating and in the course of drying of the coating and in the course of curing of the coating. The speed of rotation may be a uniform speed of rotation or a cyclical speed of rotation, where the bearing component is moved onward stepwise.

All features and/or advantages that have been mentioned in connection with the above-described method of applying a coating to a bearing component are also applicable to the arrangement for applying a coating to a bearing component.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE DRAWINGS

The invention will be described in detail hereinafter with reference to working examples shown in the drawings. The working examples and the combinations shown in the working examples are purely illustrative and are not intended to restrict the scope of protection of the invention. The latter is defined solely by the appended claims.

FIG. 1 is a schematic flowchart of a method of applying a coating to a bearing component according to an embodiment of the disclosure.

FIG. 2 is a schematic side elevational view of an apparatus for applying a coating to a bearing component according to an embodiment of the disclosure.

FIG. 3 is a front elevational view of a detail of the apparatus of FIG. 2.

FIG. 4 is a holding apparatus for use in applying a coating to a bearing component as shown in FIG. 2.

### DETAILED DESCRIPTION

Identical or functionally identical elements are identified by the same reference numerals hereinafter.

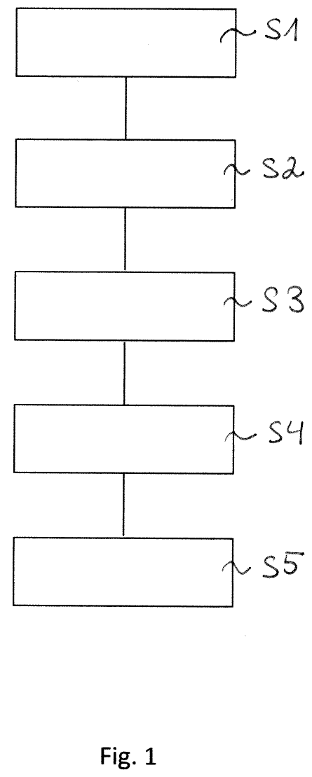

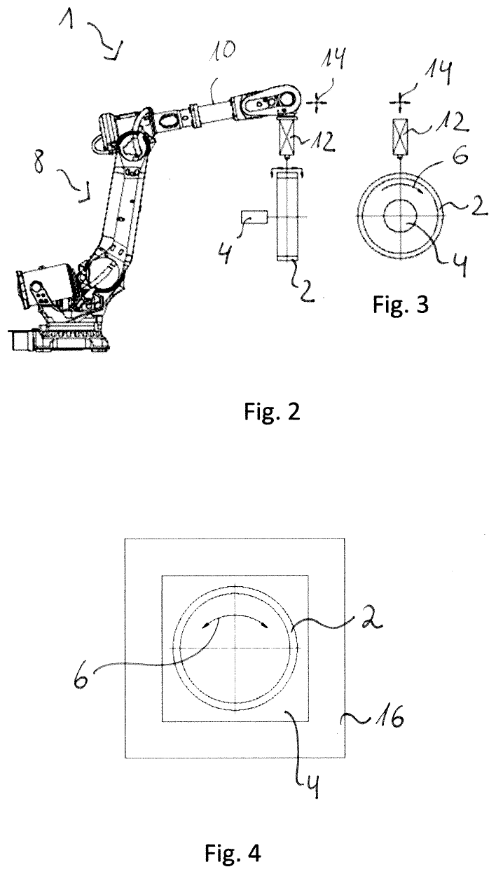

FIG. 1 is a flowchart of a method of applying a coating to a bearing component 2, and FIGS. 2 to 4 show an apparatus 1 for applying a coating to the bearing component 3 by the method. In a first step S1, the bearing component 2 is provided. The figures show the bearing component as a bearing ring. Alternatively, the bearing component may also be a rolling body, for example a cylindrical roller, a conical roller, a needle roller, a pendulum roller or the like.

The coating may especially be a sealant, for example a paint, a varnish, a resin, a resin mixture, or the like. In addition, the coating may also be applied on top of an already applied first coating. In particular, the first coating may be a thermal spray layer. For example, the first coating may have been applied by a plasma spraying method and have a porous surface. This porous surface may then in turn be sealed with at least one further coating which is applied by the method described. It is also possible to apply multiple coatings successively by the method described.

In a step S2, the bearing component is mounted in a holding apparatus 4 which is designed to rotate the bearing component at a defined speed of rotation (illustrated by arrow 6). The speed of rotation may be chosen based on a temperature, especially an ambient temperature and/or a coating temperature, a size of the bearing component and/or a viscosity of the coating. The speed of rotation may be a uniform speed of rotation or a cyclical speed of rotation, where the bearing component 2 is moved onward stepwise.

Once the bearing component 2 has been mounted in the holding apparatus 4 and set in rotation, a defined amount of a coating is applied to the bearing component 2 in a step S3. As can be seen in FIG. 2, the defined amount of the coating is applied by means of a metering system 8 having a robot system 10 comprising a nozzle 12 which is designed to spray a defined amount of the coating onto the bearing component 2, in particular in a contactless manner. The metering system is preferably designed to reproducibly apply a defined amount of the coating per unit area.

In addition, the metering system may be designed to monitor a temperature of the coating in the course of application, such that the coating is applied to the bearing component 2 at a defined temperature.

In order to achieve uniform application of the coating, the bearing component 2 is first rotated by the holding apparatus 4, and the robot system can then be moved preferably in all spatial degrees of freedom, as indicated by arrows 14.

Once the coating has been applied to the bearing component 2, in a step S4, the coating is first dried, in the course of which the holding apparatus 4 keeps the bearing component 2 in rotation, such that the coating on the bearing component 2 remains in a very substantially uniform distribution and a maximum homogeneity of layer thickness is achieved. This step may make it possible, for example, for the coating to penetrate into a porous surface of the bearing component 2. It is also conceivable that at least one further coating is applied after drying. In particular, steps S3 and S4 can be repeated with the same coating and/or a different coating until a desired layer thickness and/or coating sequence has been achieved.

Once the coating has dried, in a step S5, the holding apparatus 4 together with the bearing component is introduced into a curing device 16 in order to finally cure the coating. In order to reduce the risk of droplet formation, the bearing component is rotated at a defined speed of rotation during the curing. Depending on the coating, the curing can be effected at a temperature between 15°° C. and 300° C.

In the method described, the bearing component 1 is rotated during application, drying and curing of the coating. However, it is alternatively possible to rotate the bearing component 2 solely during curing and/or during drying and curing or during application and curing. Preferably, the bearing component 2 is kept in rotation even when the different method steps are being conducted at different stations and the bearing component 2 and/or the holding apparatus 4 is transported between the different stations.

The speed with which the bearing component 2 is rotated is preferably variably adjusted to parameters including the viscosity of the coating. For example, in the course of curing, onset of crosslinking of the molecules of the coating may cause the viscosity of the coating to change. It is possible to respond to this change with a variable speed of rotation. But it is also possible to keep the speed of rotation constant.

In addition, the speed of rotation on application, drying and curing of the coating may be the same. Alternatively, the speed of rotation on application, drying and curing may be different. As already mentioned, the speed of rotation may be matched to a viscosity, an ambient temperature, a temperature of the coating or the like. This makes it possible for the speed of rotation to be matched to the viscosity of the coating, such that it is possible to ensure that droplet formation can be efficiently prevented and a very substantially homogeneous layer thickness and/or distribution is achieved in the coating operation. It is also possible to ensure that the coating is not spun off the bearing component 2 owing to excessively high centrifugal forces by keeping the speed of rotation below a defined limit.

In summary, a method and an arrangement for application of a coating to a bearing component are provided, in which the risk of droplet formation is reduced. Active rotation of the bearing component 2 at least on curing of the coating can ensure a uniform and homogeneous distribution of the coating. This can avoid running of the coating of the bearing component as a result of droplet formation, with the result that sufficient coating cannot be achieved. In addition, droplet formation can be reduced or even avoided, which can avoid laborious reworking of the bearing component for removal of droplets. It is additionally possible to avoid distribution of a coating on areas of the bearing component 2 that are not supposed to be coated, for example a raceway of a bearing ring.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and arrangements for coating a bearing component.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### List of Reference Signs

1 arrangement
2 bearing component
4 holding apparatus
6 arrow
8 metering system
10 robot system
12 nozzle
14 arrow
16 curing device
S1-S5 method steps

What is claimed is:

1. A method comprising:
providing a bearing component in a holding apparatus,
applying a defined amount of a coating material to the bearing component, and
curing the coating on the bearing component while using the holding apparatus to rotate the bearing component at a first speed.

2. The method according to claim 1,
including rotating the bearing component at a second speed while applying the defined amount of the coating material to the bearing component.

3. The method according to claim 2,
including, before the curing, rotating the bearing component at a third speed while drying the coating material on the bearing component.

4. The method according to claim 3,
wherein the first speed, the second speed and/or the third speed is constant.

5. The method according to claim 3,
wherein the first speed, the second speed and/or the third speed is variable.

6. The method according to claim 3,
wherein the first speed is the same as the second speed and the second speed is the same as the third speed.

7. The method according to claim 3,
wherein the first speed is different than the second speed and the third speed is different than the first speed and the second speed.

8. The method according to claim 3,
wherein the first speed and/or the second speed and/or the third speed is selected based on a temperature, a size of the bearing component and/or a viscosity of the coating.

9. An apparatus for applying a coating material to a bearing component comprising:
a holding device configured to hold the bearing component and to rotate the bearing component,
an application device configured to apply a defined amount of the coating material to the bearing component, and
a curing device configured to cure the coating on the bearing component while the bearing component is being rotated by the holding apparatus at a first speed.

10. The apparatus according to claim 9,
wherein the holding device is configured to rotate the bearing component at a constant or variable speed.

11. The apparatus according to claim 9,
wherein the holding device is configured to rotate the bearing component at a second speed while applying the defined amount of the coating material.
